(19) United States
(12) Patent Application Publication
(10) Pub. No.: US 2025/0338784 A1
(43) Pub. Date: Nov. 6, 2025

(54) Multipurpose Foot Powered System

(71) Applicant: James Smith, Kennewick, WA (US)

(72) Inventor: James Smith, Kennewick, WA (US)

(21) Appl. No.: 19/082,677

(22) Filed: Mar. 18, 2025

Related U.S. Application Data
(60) Provisional application No. 63/641,082, filed on May 1, 2024.

(51) Int. Cl. A01B 1/16; A01B 1/02; A01B 1/20; A01B 1/22

(52) U.S. Cl. CPC A01B 1/16; A01B 1/024; A01B 1/20; A01B 1/22

(57) ABSTRACT

A multipurpose foot-powered system is disclosed which is a set of foot-powered and hand-operated tools which break up the structure of compacted earth. Specifically, the system comprises a kick-pick tool and a twist-pick tool. The kick-pick tool measures approximately 5-6 feet in length. It resembles a shovel with a hooded steel pick or hooded chisel tip for a blade. The blade is slightly curved like a shovel and an integral footrest is positioned at a convenient distance from the tip of the hooded blade, which will allow the user to drive the hooded blade into the earth with their foot. The twist-pick tool is similar in design, however the tool is entirely straight from its tip through its handle. The footrest height is adjustable by the user and the handle has a T-shaped crossbar that enables a user to twist the hooded blade about the long axis of the twist-pick.

### CROSS-REFERENCE TO RELATED APPLICATION

The present application claims priority to, and the benefit of, U.S. Provisional Application No. 63/641,082, which was filed on May 1, 2024, and is incorporated herein by reference in its entirety.

### FIELD OF THE INVENTION

The present invention relates generally to the field of multipurpose foot-powered systems. More specifically, the present invention relates to a set of tools for easily digging through and breaking up compacted earth and stony soils. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in multipurpose foot-powered systems. Generally, digging through lawns, compacted earth, and stony soils are laborious and time-consuming jobs. For example, trying to penetrate compacted or stony soils with a shovel or post hole digger is often quite difficult, and may cause damage to the tool. A pick-axe or digging bar fare better at the same task but the work is still challenging upper body strength reliant work.

Further, using conventional tools to free weeds with their roots is challenging because the user can't see the roots. Typically, a user damages the lawn when removing such weeds. Additionally, use of a shovel or pick-axe may damage buried utility and sprinkler lines, even when the location of the lines is generally known.

Accordingly, there is a demand for an improved multipurpose foot-powered system that can easily and rapidly turn seemingly impenetrable ground into easily shoveled fluff. More particularly, there is a demand for a set of tools that speeds and eases weeding tasks.

Therefore, there exists a long felt need in the art for a multipurpose foot-powered system that provides users with a set of tools that speeds and cases weeding tasks by easily breaking the structure of compacted soils beneath the weed, thus freeing weed roots from the earth that binds them. There is also a long felt need in the art for a multipurpose foot-powered system that saves considerable time and effort for homeowners, gardeners, fence builders, and construction workers when working compacted soil by preparing the ground to case such tasks as digging, trenching, weeding, and transplanting. Further, there is a long felt need in the art for a multipurpose foot-powered system that includes a kick-pick tool that enables users to remove weeds with their roots, preserve the roots of transplanted shrubbery, cultivate garden beds, help expose utility lines, and lift rocks without excessively damaging lawn, landscaping or utilities. Moreover, there is a long felt need in the art for a system that includes a twist-pick tool that aids users in rapidly and easily digging post holes with a post hole digger by preparing the soil for the most efficient use of the post hole digger. Further, there is a long felt need in the art for a multipurpose foot-powered system that utilizes a footrest so that a user can easily drive the tools into the ground using their foot. Finally, there is a long felt need in the art for a multipurpose foot-powered system that cases and speeds up manual labor and selectively removes undesired items from the earth.

The subject matter disclosed and claimed herein, in one embodiment thereof, comprises a multipurpose foot-powered system. The system is a set of foot-powered and hand-operated tools which break up the structure of compacted earth. Specifically, the system comprises a kick-pick tool and a twist-pick tool. Both tools comprise a hood located near the tip of the blade. The hood is essential, as it greatly extends the capacity of the device to break up the structure of the soil without overly hindering the device's insertion into the ground. The kick-pick tool measures approximately 5-6 feet in length. It resembles a shovel with a hooded steel pick or hooded chisel tip for a blade. The blade is slightly curved like a shovel and an integral footrest is positioned at a convenient distance from the tip of the blade, which will allow the user to drive the blade of the tool into the earth with their foot. The twist-pick tool is similar in design, however the tool is entirely straight from its tip through its handle. The footrest is adjustable along the length of the tool and the handle has a T-shaped crossbar that enables a user to twist the tool back and forth about the long axis of the twist-pick.

In this manner, the multipurpose foot-powered system of the present invention accomplishes all of the forgoing objectives and provides users with a set of tools that break up the earth in precise user specified areas. The set of tools are foot-powered and save time and effort for homeowners, gardeners, fence builders, and construction workers.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multipurpose foot-powered system. The system is a set of foot-powered and hand-operated tools which break up the structure of compacted earth. Specifically, the system comprises a kick-pick tool and a twist-pick tool. The kick-pick tool resembles a shovel with a hooded steel pick-like blade. The blade is slightly curved like a shovel and an integral footrest allows the user to drive the blade of the tool into the earth with their foot. The twist-pick tool is similar in design, however the tool is entirely straight from its tip through its handle. The footrest is adjustable along the length of the tool and the handle has a T-shaped crossbar that enables a user to twist the tool back and forth about the long axis of the twist-pick.

In one embodiment, the multipurpose foot-powered system comprises a set of tools which case and speed digging through lawns, compacted earth, and stony soils. The system saves considerable time and effort for homeowners, gardeners, fence builders, and construction workers, etc., when working compacted soil by preparing the ground to case such tasks, as digging, trenching, weeding, and transplanting. The set of tools include a kick-pick tool and a twist-pick tool which are foot-powered and hand-operated tools used to break the structure of compacted earth. Both tools comprise a footrest so that a user can easily drive the respective blades into the compacted earth and stony soil with their feet and have two distinct variations in operation. Both tools comprise a hood located near the tip of the blade. The hood is essential to the design intent of most applications of the tool. The hood greatly extends the capacity of the tools to break up the structure of the soil without overly hindering the pick's insertion into the ground. The kick-pick tool operates with a prying motion with the hood implanted in the material to be broken up as would a shovel and enables users to remove weeds with their roots, preserve the roots of transplanted shrubbery, cultivate garden beds, help expose utility lines, and lift rocks without excessively damaging lawn, landscaping or utilities. It also prepares the soil for a more efficient use of a shovel. The twist-pick tool operates by means of twisting the tool, in particular the hood of the blade, in the material to be broken up and aids users in rapidly and easily digging post holes with a post hole digger by preparing the soil for the most efficient use of the post hole digger.

In one embodiment, the kick-pick tool is a tool for easily breaking the structure of compacted soil for numerous purposes, including freeing weeds with their roots from the soil that binds their roots. The kick-pick tool comprises a blade component secured to a footrest platform component, which in turn is secured to a handle component via a shank component. The footrest platform component serves to offset the handle from the footrest for user convenience in controlling the tool. Further, the tool measures approximately 5-6 feet in length, but can be any suitable length as is known in the art, depending on the needs and/or wants of a user. The shank component, footrest platform component, and the blade component are typically one piece, formed metal, such as steel. In another embodiment, the footrest platform component is secured to the blade component via welding or other suitable securing means as is known in the art. Also, in another embodiment, the shank component is secured to the footrest platform component via welding or other suitable securing means as is known in the art. In one embodiment, the shank component is configured in a conventional shank shape with an opening which accepts an end of the handle component. In another embodiment, the conventional handle with an opening accepts the end of the shank component. Further, the shank component is sturdily secured to the handle component via welding, epoxy, crimping, a pinned hole, a screw, etc.

In one embodiment, the handle component is typically no more than approximately six feet long, for user convenience. The handle component is typically made of a stout material, such as hardwood, fiberglass, or steel, etc., or any other durable material as is known in the art. The handle component is typically an elongated cylindrical configuration with an opposing first end and a second end. The first end is utilized as a gripping section for use by the user and the second end is secured to the shank component.

In one embodiment, the blade component measures approximately 10-16 inches in length as measured from tip to footrest platform. The blade component is slightly curved in shape, much like a conventional shovel or garden fork. The blade component comprises a concave front surface and a convex rear surface, with a tip component and a hood component. The blade is attached to the footrest platform component as an integral piece or via welding, screws, etc. The footrest platform component secures the footrest and serves to offset the handle from the footrest for user convenience in controlling the tool. The footrest platform component is secured to the shank component as an integral piece or via welding, screws, etc. In operation, the tip end is inserted into the ground along with the hood. The tip component comprises a pick point or a chisel tip depending on the application.

In one embodiment, a steel hood is secured about one to four inches back from the chisel tip or pick point (i.e., tip) of the blade component. The distance that the hood is set back from the tip, is as close to the tip as the geometry of the tip permits without impeding the specific function of the tip. The hood can be any suitable shape or size as is known in the art, depending on the application. For example, depending on the application the hood can be circular, oval, or triangular, etc., and of varying size. The hood component is secured to the blade component as an integral piece or via welding, screws, etc.

In one embodiment, the footrest platform component and footrest are positioned at a convenient distance from the tip of the blade component, which will allow a user to drive the blade of the tool into the earth with their foot. Specifically, the footrest is secured to the footrest platform component via welding, bolts, nuts, etc. In one embodiment, the footrest is an integral steel footrest. The footrest is sized and shaped to accommodate at least one foot of a user.

In one embodiment, the footrest-to-blade, footrest platform to blade, and footrest platform to shank component attachments will be gusseted or bracketed as needed to support the tool in its intended use. Further, in operation the kick-pick tool operates with a prying motion through the hood as a conventional shovel and has a straight handle component and an integrated footrest that enable users to lever its hooded blade component up against the soil beneath a weed or other object that is embedded in the ground. This action breaks the structure of the soil that surrounds the embedded object facilitating easy removal. After removing a weed from a lawn, the user can restore the appearance of the lawn by tapping the displaced lawn back into place with their foot.

In one embodiment, the twist-pick tool is similar in design to the kick-pick tool, with some exceptions. Unlike the kick-pick, the tool is entirely straight from its tip through its handle component. The twist-pick tool is a tool that operates by means of twisting the tool, specifically the hood of the blade, back and forth in the material to be broken-up. The twist-pick tool comprises a blade component secured to a handle component via a shank component. Further, the overall tool measures approximately 5-6 feet in length, but can be any suitable length as is known in the art, depending on the needs and/or wants of a user. The shank component and the blade component are typically one piece, formed metal, such as steel. The shank component is secured to the blade component via welding or other suitable securing means as is known in the art. In one embodiment, the shank component is configured in a conventional shank shape with an opening which accepts an end of the handle component. In another embodiment, the conventional handle with an opening accepts the end of the shank component. Further, the shank component is sturdily secured to the handle component via welding, epoxy, crimping, a pinned hole, a screw, etc.

In one embodiment, the handle component is typically no more than approximately six feet long, for user convenience. The handle component is typically made of a stout material, such as hardwood, fiberglass, or steel, etc., or any other durable material as is known in the art. The handle component is typically an elongated cylindrical configuration with an opposing first end and a second end. The first end comprises a T-shaped crossbar that enables the user to easily twist the tool back and forth, thus twisting the hood back and forth in the soil, about the long axis of the tool. The T-shaped crossbar is utilized as a gripping section for use by the user. The second end is secured to the shank component.

In one embodiment, the blade component measures approximately 4-12 inches in length as measured from tip to shank component. The blade component comprises a tip and a hood. The shank, handle or both may comprise the footrest platform. Additionally, the footrest platform is comprised of a hard smooth surface or toothed rail. In one embodiment, the footrest platform is attached as an integral piece or via welding, screws, etc. In another embodiment, in which the shank comprises the footrest platform, the shank with its footrest platform, is lengthened (and the handle shortened) to accommodate the full range of adjustment for the adjustable footrest along the shank. In yet another embodiment, in the which the handle comprises the footrest platform, the handle is lengthened, with its footrest platform, (and the shank shortened) to accommodate the full range of adjustment for the adjustable footrest along the handle. Further, the length of the shank is no longer than that needed to secure the blade to the handle. In another embodiment, the footrest platform extends along both the shank and the handle. The footrest platform component is attached to the shank component, handle component or both as an integral piece or via welding, screws, etc. In operation, the tip end is inserted into the ground along with the hood component.

In one embodiment, a steel hood is secured about one to four inches back from the chisel tip or pick point tip of the blade component. The hood can be any suitable shape or size as is known in the art, depending on the application. For example, depending on the application the hood can be circular, oval, or triangular, etc.

In one embodiment, an adjustable footrest is positioned by the user along the handle or shank mounted footrest platform at a convenient distance from the tip of the blade component, which will allow a user to drive the blade of the tool into the earth with their foot. In one embodiment, the adjustable footrest is comprised of a tread platform, a tread, a locking pin and a clinch pin. The tread platform secures the tread and serves to offset the handle from the tread for user convenience in controlling the tool. The locking pin and clinch pin act to secure the adjustable footrest against the handle mounted footrest platform when the user applies his weight to the tread of the adjustable footrest, and also, when released, they allow the footrest to be moved up and down along the shank or handle. It is readily appreciated that there are numerous other methods for securing the adjustable footrest to the twist-pick which are commonly known in the art. Of which the foregoing embodiment is but one example. The adjustable footrest can be moved, as needed, so that the tool can be comfortably driven into post holes of varying depth. The footrest is sized and shaped to accommodate at least one foot of a user.

Further, in operation the twist-pick tool operates with a twisting motion and has a T-shaped crossbar component attached to the first end of the handle component that enable users to maintain a secure grip on the tool while twisting the hooded blade back and forth about its long axis to loosen compacted earth in the bottom of a post hole. The loosened earth is then easily and rapidly removed by a post hole digger.

In yet another embodiment, the multipurpose foot-powered system comprises a plurality of indicia.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the multipurpose foot-powered system of the present invention showing the set of tools in accordance with the disclosed architecture;

FIG. 2 illustrates a left side view of one embodiment of the kick-pick tool of the present invention showing detail of the tip through the shank's insertion into the handle in accordance with the disclosed architecture;

FIG. 3 illustrates a front side view of one embodiment of the kick-pick tool of the present invention showing detail of the tip through the shank's insertion into the handle in accordance with the disclosed architecture;

FIG. 4 illustrates an oblique top side view of one embodiment of the kick-pick tool of the present invention showing detail of the tip through the shank's insertion into the handle in accordance with the disclosed architecture;

FIG. 5 illustrates a perspective view of one embodiment of the kick-pick tool of the present invention in use showing the tool as it is ready to be driven into the earth in accordance with the disclosed architecture;

FIG. 6 illustrates a perspective view of one embodiment of the kick-pick tool of the present invention in use showing the tool inserted into the earth and before it is used to break the structure of the soil beneath a weed in accordance with the disclosed architecture;

FIG. 7 illustrates a perspective view of one embodiment of the kick-pick tool of the present invention in use showing the tool inserted into the earth and as it is being used to break the structure of the soil surrounding a weed in accordance with the disclosed architecture;

FIG. 8 illustrates a perspective view of one embodiment of the kick-pick tool of the present invention showing a user removing a weed and its roots after having used the tool to disrupt the soil structure surrounding the weed in accordance with the disclosed architecture;

FIG. 9 illustrates a perspective view of one embodiment of the twist-pick tool of the present invention showing the adjustable footrest and components in accordance with the disclosed architecture;

FIG. 10 illustrates a series of orthographic projections of one embodiment of the twist-pick tool of the present invention showing views of the adjustable footrest as it is mounted on the handle;

FIG. 11 illustrates a left side view of the adjustable footrest in both the locked and unlocked orientations relative to the handle;

FIG. 12 illustrates a perspective view of one embodiment of the twist-pick tool of the present invention positioned for use in accordance with the disclosed architecture; and

FIG. 13 illustrates a perspective view of one embodiment of the twist-pick tool of the present invention showing the user twisting the blade back and forth in the earth and thus breaking up the earth at the bottom of the posthole for removal by a post hole digger in accordance with the disclosed architecture;

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a multipurpose foot-powered system that provides users with a set of tools that speeds and cases weeding tasks by easily breaking the structure of compacted soils, thus freeing weed roots from the earth that binds them. There is also a long felt need in the art for a multipurpose foot-powered system that saves considerable time and effort for homeowners, gardeners, fence builders, and construction workers when working compacted soil by preparing the ground to case such tasks as digging, trenching, weeding, and transplanting. Further, there is a long felt need in the art for a multipurpose foot-powered system that includes a kick-pick tool that enables users to remove weeds with their roots, preserve the roots of transplanted shrubbery, cultivate garden beds, help expose utility lines, and lift rocks without excessively damaging lawn, landscaping or utilities. Moreover, there is a long felt need in the art for a system that includes a twist-pick tool that aids users in rapidly and easily digging post holes with a post hole digger by preparing the soil for the most efficient use of the post hole digger. Further, there is a long felt need in the art for a multipurpose foot-powered system that utilizes a footrest so that a user can easily drive the tools into the ground using their foot. Finally, there is a long felt need in the art for a multipurpose foot-powered system that cases and speeds up manual labor and selectively removes undesired items from the earth.

The present invention, in one exemplary embodiment, is a novel multipurpose foot-powered system. The system is a set of foot-powered and hand-operated tools which break up the structure of compacted earth. Specifically, the system comprises a kick-pick tool and a twist-pick tool. The kick-pick tool measures approximately 5-6 feet in length. It resembles a shovel with a hooded steel pick or chisel tip for a blade. The blade is slightly curved like a shovel and an integral footrest is positioned at a convenient distance from the tip of the blade, which will allow the user to drive the hooded blade of the tool into the earth with their foot. The twist-pick tool is similar in design, however the tool is entirely straight from its tip through its handle. The footrest is adjustable and the handle has a T-shaped crossbar that enables a user to twist the hood of the blade back and forth in the soil about the long axis of the twist-pick.

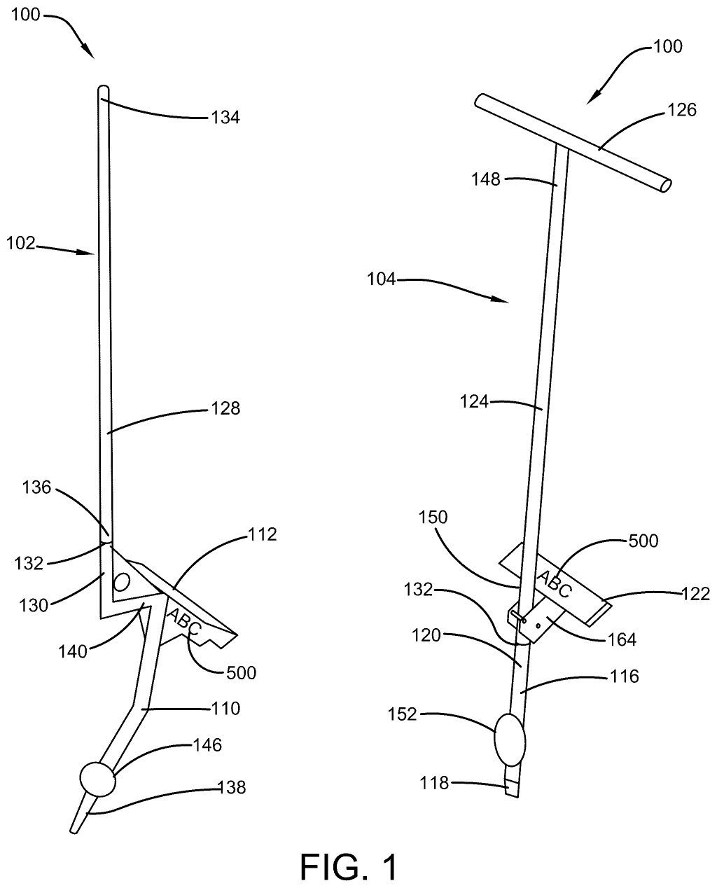

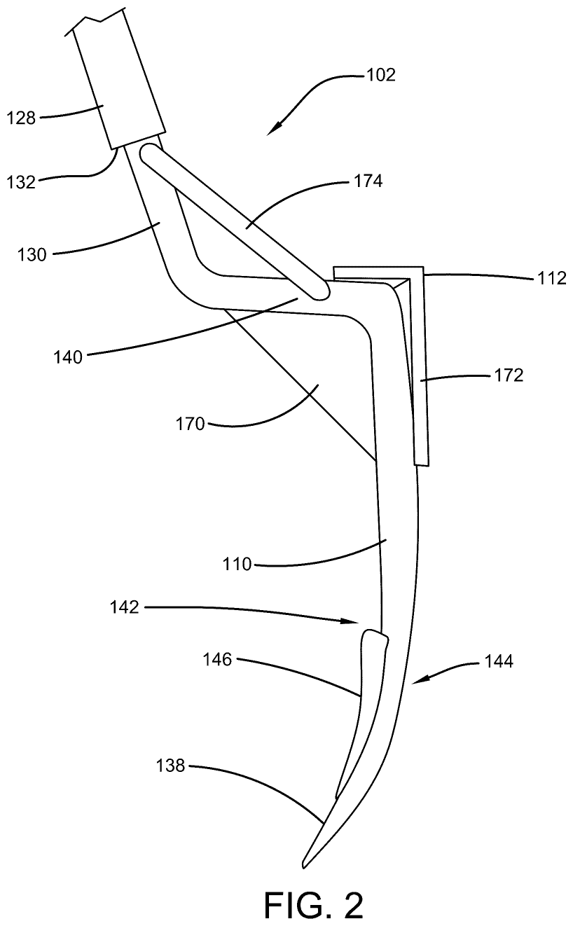

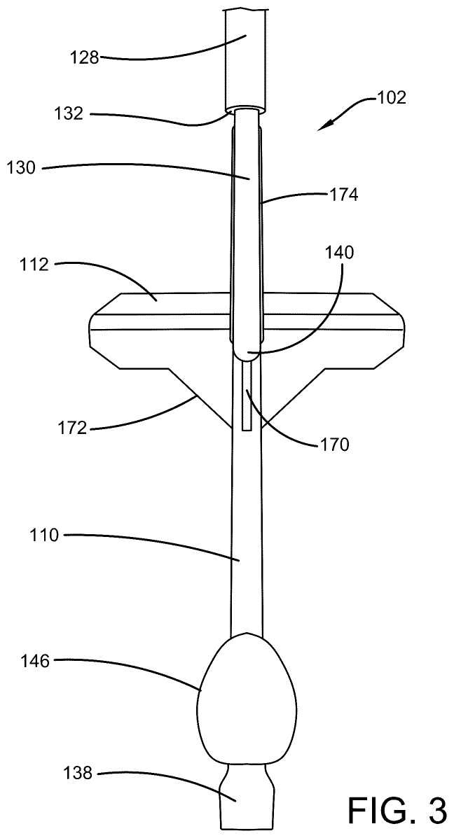

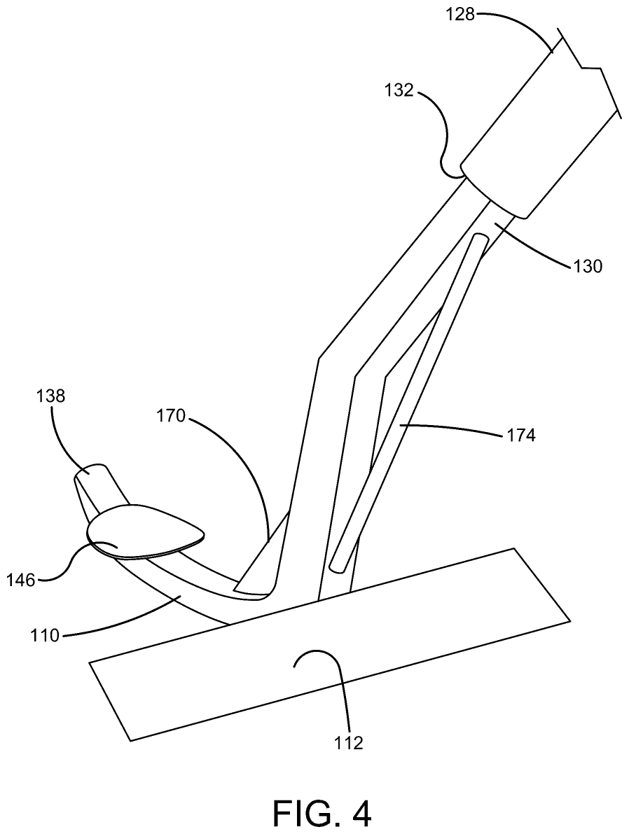

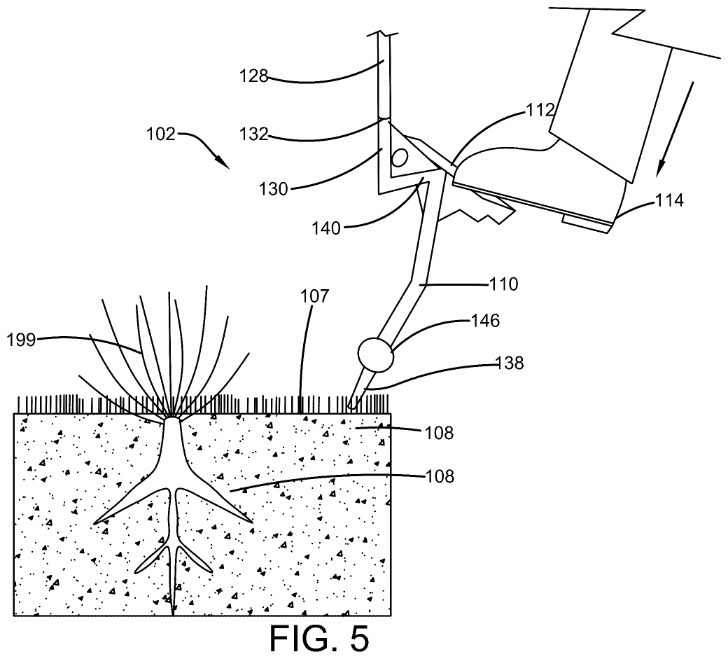

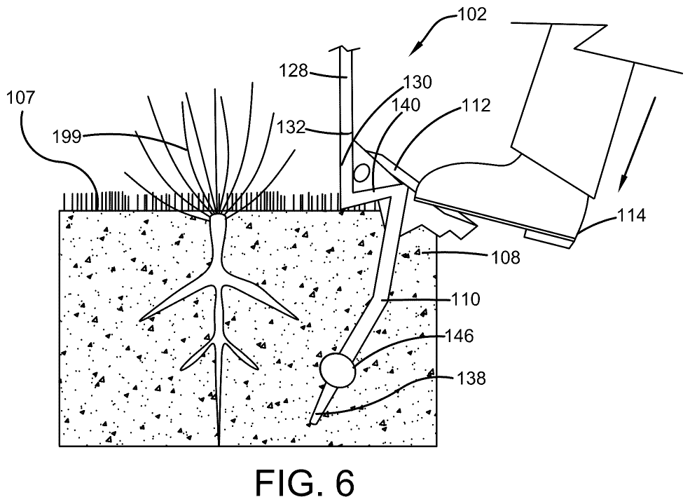

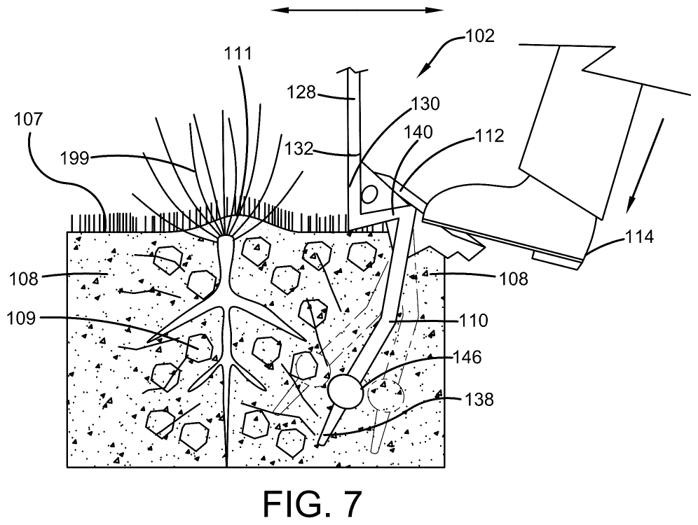

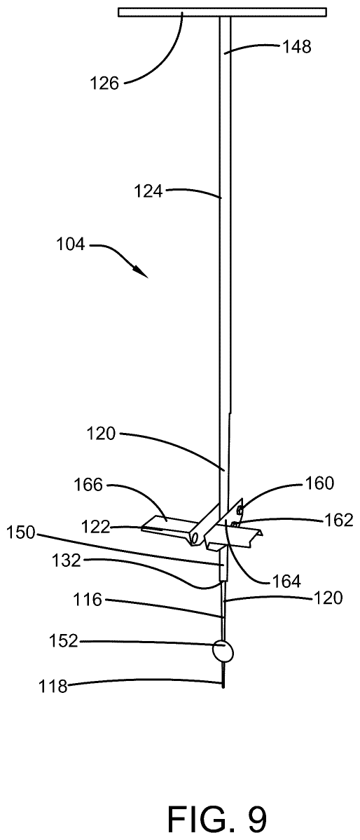

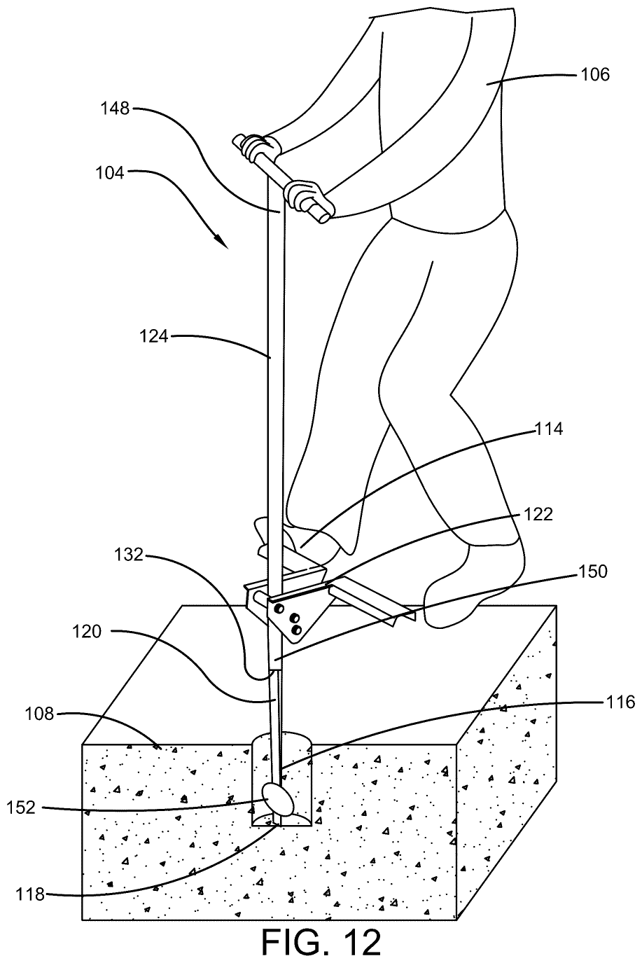

Referring initially to the drawing, FIG. 1 illustrates a perspective view of one embodiment of the multipurpose foot-powered system 100 of the present invention. In the present embodiment, the multipurpose foot-powered system 100 is an improved multipurpose foot-powered system 100 that provides a user 106 (see FIGS. 5-8 and 12-13) with a set of tools for quickly and easily penetrating and breaking up the earth 108. Specifically, the multipurpose foot-powered system 100 comprises a kick-pick tool 102 and a twist-pick tool 104, which are a set of foot-powered and hand-operated tools which break up the structure of compacted earth 108. Specifically, the kick-pick tool 102 resembles a shovel with a hooded steel pick-like blade 110. As shown in FIGS. 1 and 2-8, the blade 110 is slightly curved like a shovel and an integral footrest 112 allows the user 106 to drive the tip 138 of the blade 110 with the attached hood 146 into the earth 108 with their foot 114. The twist-pick tool 104, shown in FIGS. 1 and 9-13 is similar in design, however the twist-pick 104 is entirely straight from its tip 118 through its handle component 124. The footrest 122 is adjustable along the entire length of the handle 124. In one embodiment, as shown in FIG, 10, the handle 124 comprises a footrest platform 119 that supports the adjustable footrest. In another embodiment, the handle 124 serves as the footrest platform. Referring to FIGS. 1 and 12-13, the handle component 124 has a T-shaped crossbar 126 that enables a user 106 to twist the twist-pick 104 back and forth about the long axis of the twist-pick 104.

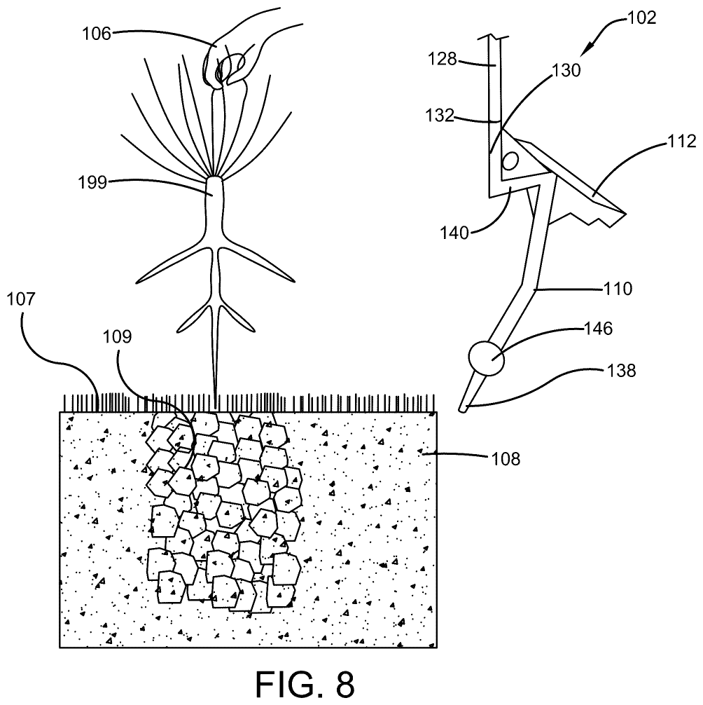

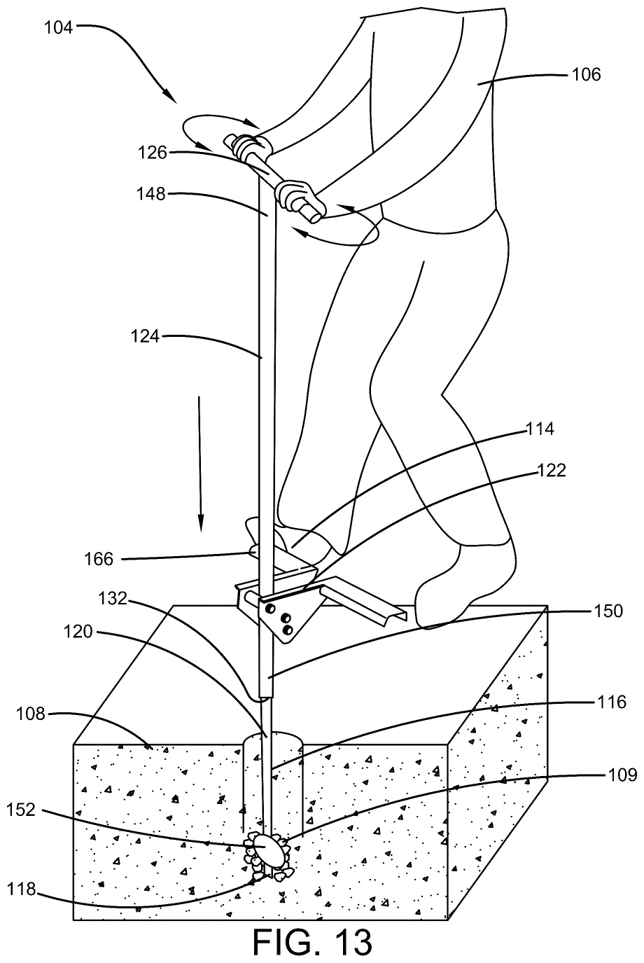

Generally, the multipurpose foot-powered system 100 comprises a set of tools 102, 104 which case and speed digging through lawns 107, compacted earth 108, and stony soils by breaking the soil structure into easily displaced clods of broken earth 109 as shown in FIGS. 8 and 13. The system 100 saves considerable time and effort for homeowners, gardeners, fence builders, and construction workers, etc., when working compacted soil by preparing the ground to case such tasks, as digging, trenching, weeding, and transplanting. The set of tools 100 are foot-powered and hand-operated. Both tools 102, 104 comprise a footrest 112, 122 so that a user 106 can easily drive the respective blades 110, 116 into the compacted earth 108 and stony soil with their feet 114 and have two distinct variations in operation. The kick-pick tool 102 operates with a prying motion against the hood 146 as would a shovel and enables users 106 to remove weeds 199 with their roots, preserve the roots of transplanted shrubbery, cultivate garden beds, help expose utility lines, and lift rocks without excessively damaging lawn 107, landscaping or utilities. It also prepares the soil for a more efficient use of a shovel. The twist-pick tool 104 operates by means of twisting the tool 104, specifically the hood 152 of the blade 116, back and forth in the material to be broken up and aids users 106 in rapidly and easily digging post holes with a post hole digger by preparing the soil for the most efficient use of the post hole digger.

As shown in FIGS. 5-8, the kick-pick tool 102 is a tool for easily breaking the structure of compacted soil 108 for numerous purposes, including freeing weeds 199 from soil with their roots. The kick-pick tool 102 comprises a blade component 110 secured to a footrest platform component 140. The footrest platform component 140 is secured to the handle component 128 via a shank component 130. The footrest platform component 140 secures the footrest 112 and serves to offset the handle 128 from the footrest 112 for user 106 convenience in controlling the tool 102. Further, the tool 102 measures approximately 5-6 feet in length, but can be any suitable length as is known in the art, depending on the needs and/or wants of a user 106. The shank component 130, footrest platform component 140 and the blade component 110 are typically one piece, formed metal, such as steel. In another embodiment, one or both of the shank component 130 and blade component 110 are secured to the footrest platform component 119 via welding or other suitable securing means as is known in the art. In one embodiment, the shank component 130 is configured in a conventional shank shape with an opening 132 in the shank 130 which accepts the second end 136 of the handle component—128. In another embodiment, the second end 136 of the handle component 128 is configure with an opening 132 to receive the solid shank 130. The shank component 130 is sturdily secured to the handle component 128 via welding, epoxy, crimping, a pinned hole, a screw, etc.

Further, the handle component 128 is typically no more than approximately six feet long, for user convenience. The handle component 128 is typically made of a stout material, such as hardwood, fiberglass, or steel, etc., or any other durable material as is known in the art. The handle component 128 is typically an elongated cylindrical configuration with an opposing first end 134 and a second end 136. The first end 134 is utilized as a gripping section for use by the user 106 and the second end 136 is secured to the shank component 130.

Additionally, the blade component 110 measures approximately 10-16 inches in length as measured from tip 138 to footrest platform 140. The blade component 110 is slightly curved in shape, much like a conventional shovel or garden fork. The blade component 110 comprises a concave front surface 142 and a convex rear surface 144, with a tip 138 and a hood 146.

The footrest platform 140 and footrest 112 are positioned at a convenient distance from the tip 138 of the blade component 110, which will allow a user 106 to drive the tip 138 of the blade 110 with the hood 146 into the earth 108 with their foot 114. Specifically, the footrest 112 is secured to the footrest platform 140 via welding, bolts, nuts, etc. In one embodiment, the footrest 112 is an integral steel footrest. The footrest 112 is sized and shaped to accommodate at least one foot 114 of a user 106.

Furthermore, a steel hood 146 is secured about one to four inches back from the pick point or chisel tip (i.e., tip 138) of the blade component 110. The distance that the hood 146 is set back from the tip 138, is as close to the tip as the geometry of the tip 138 permits without impeding the specific function of the tip. The hood 146 can be any suitable shape or size as is known in the art, depending on the application. For example, depending on the application the hood 146 can be circular, oval, or triangular, etc. In operation, the tip end 138 is inserted into the ground 108 along with the hood 146. The tip component comprises a pick point or a chisel tip depending on the application.

Further, footrest platform 140 to blade 110, footrest platform 140 to shank 130, and footrest 122 to blade 110 attachments will be gusseted or bracketed as needed to support the tool 102 in its intended use. Further, in operation the kick-pick tool 102 operates with a prying motion against the hood 146 as a conventional shovel and has a handle component 128 and an integrated footrest 112 that enable users 106 to lever its hooded blade component 110 up against the soil 108 beneath a weed 199 or other object that is embedded in the ground 108. This action breaks the structure of the compacted soil 108 that surrounds the embedded object facilitating easy removal from the broken soil 109. After removing a weed from a lawn, the user 106 can restore the appearance of the lawn 107 by tapping the displaced lawn 111 back into place with their foot.

As shown in FIGS. 1, 9, 12 and 13, the twist-pick tool 104 is similar in design to the kick-pick tool 102, with some exceptions. Unlike the kick-pick, the tool 104 is entirely straight from its tip 118 through its handle component 124. The twist-pick tool 104 is a tool that operates by means of twisting the tool 104, specifically the hood 152 of the blade 116, in the material to be broken-up. The twist-pick tool 104 comprises a blade component 116 secured to a handle component 124 via a shank component 120. Further, the tool 104 measures approximately 5-6 feet in length, but can be any suitable length as is known in the art, depending on the needs and/or wants of a user 106. The shank component 120 and the blade component 116 are typically one piece, formed metal, such as steel. In another embodiment, the shank component 120 is secured to the blade component 116 via welding or other suitable securing means as is known in the art. The shank component 120 is configured in a conventional shank shape with an opening 132 which accepts a second end 150 of the handle component 124. In another embodiment, an opening in the handle receives the solid shank. Further, in either embodiment, the shank component 120 is sturdily secured to the handle component 124 via welding, epoxy, crimping, a pinned hole, a screw, etc.

Further, the handle component 124 is typically no more than approximately six feet long, for user convenience. The handle component 124 is typically made of a stout material, such as hardwood, fiberglass, or steel, etc., or any other durable material as is known in the art. The handle component 124 is typically an elongated cylindrical configuration with an opposing first end 148 and a second end 150. As shown in FIG. 13, the first end 148 comprises a T-shaped crossbar 126 that enables the user 106 to easily twist the tool 104 back and forth about the long axis of the twist-pick 104, thus twisting the hood 152 back and forth in the soil 108, and thus breaking the structure of the soil 109. The T-shaped crossbar 126 is utilized as a gripping section for use by the user 106. The second end 150 of the handle 128 is secured to the shank component 120.

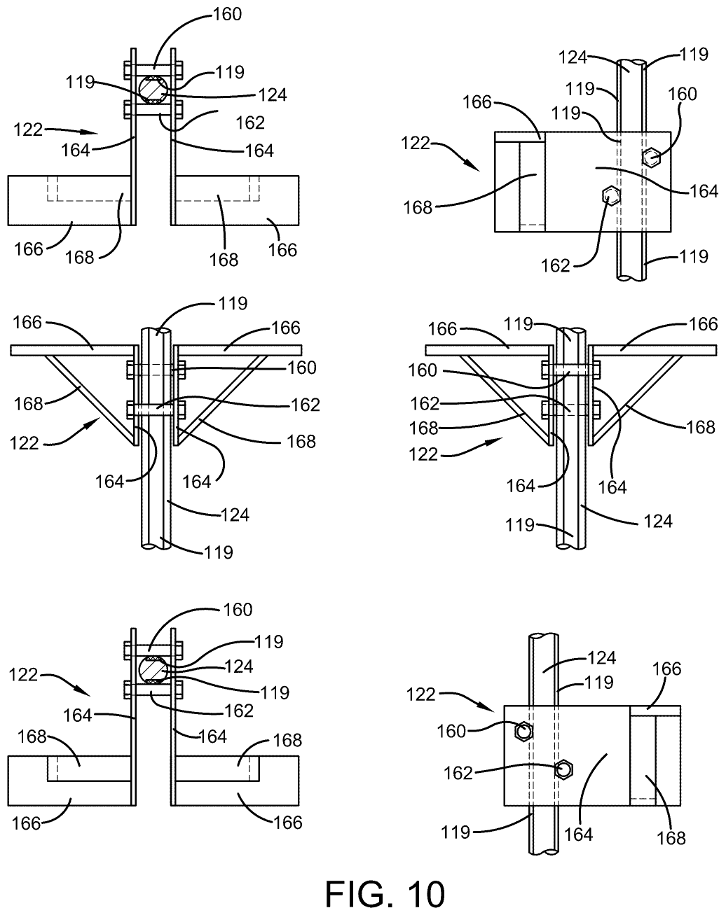

Additionally, the blade component 116 measures approximately 4-12 inches in length as measured from tip 118 to shank 120, which shank 120 begins a short distance past the hood 152. This distance marks the blade end of the shank 120. The length of the shank 120 from this point depends upon the embodiment of the twist-pick. As shown in FIG. 10, the adjustable footrest 122 is adjusted along a footrest platform 119 that is integral with the handle 124. In another embodiment, the footrest platform 119 is attached to the shank 120. The footrest platform 119 is attached as an integral piece or via welding, epoxy, screws, etc. The component that comprises the footrest platform 119 necessarily dictates which component will also support the adjustable footrest 122. So, for a handle mounted adjustable footrest 122 embodiment (which is a short shank embodiment) the shank extends past the hood 152 just far enough to engage the handle 124 securely. In another embodiment, in which the shank 120 comprises the footrest platform 119, the handle 124 is necessarily shortened and the shank 120 extends from the hood 152 toward the handle end 148 of the shank 120 to accommodate the full range of adjustment required for the adjustable footrest 122 along the shank 120. The footrest platform 119 that is integral with, or affixed to, either the handle 124 (in the embodiment of the shorter shank 120) or to the shank 120 (in the embodiment with the longer shank 120) may also comprise a toothed backing (instead of a smooth surface) along their respective front surface lengths to quickly reposition and more securely engage the adjustable footrest.

The blade component 116 comprises a tip 118, a hood 152, and a short continuation of the blade shaft which transitions to the shank 120. The blade component 116 is attached to the shank component 120 as an integral piece or via welding, screws, etc. The tip component 118 comprises a pick point or a chisel tip depending on the application. Furthermore, a steel hood 152 is secured about one to four inches back from the tip 118 of the blade component 116. The distance that the hood 152 is set back from the tip 118, is as close to the tip 118 as the geometry of the tip 118 permits without impeding the specific function of the tip 118. The hood 152 can be any suitable shape or size as is known in the art, depending on the application. For example, depending on the application the hood 152 can be circular, oval, or triangular, etc. In operation, the tip end 118 with the hood 152 is inserted into the ground 108.

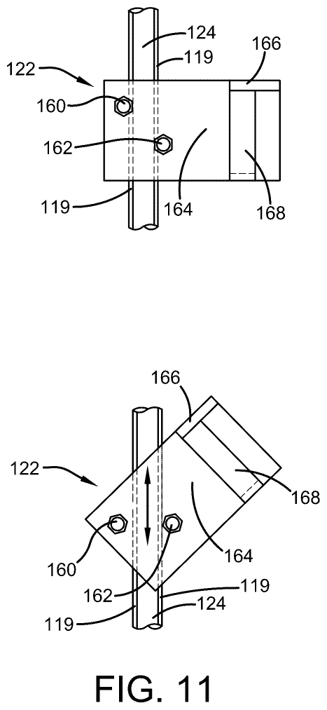

Additionally, as shown in FIGS. 1 and 9-13, an adjustable footrest 122 is positioned by the user along the footrest platform 119 at a convenient distance from the tip 118 of the blade component 116, which will allow a user 106 to drive the tip 118 of the blade 116 with the hood 152 into the earth 108 with their foot 114. The footrest platform 119 on the twist-pick 104 runs the entire length of handle and/or shank on which the adjustable footrest 122 can be positioned. As shown in FIG. 10, the adjustable footrest component 122 is comprised of a tread platform component 164, a tread component 166, a locking pin 160 and a clinch pin 162. The tread platform component 164 secures the tread component 166 and serves to offset the handle 124 from the tread 166 for user convenience in controlling the tool. As shown in FIG. 11, the locking pin 160 and clinch pin 162 act to secure the adjustable footrest 122 by pinning the adjustable footrest 122 against the footrest platform 119 when the user 106 applies his weight to the tread of the adjustable footrest 122, and also, when released, they allow the footrest 122 to be moved up and down along the shank or handle. It is readily appreciated that there are numerous other methods for securing the adjustable footrest 122 to the footrest platform 119 which are commonly known in the art. Of which the foregoing embodiment is but one example. The adjustable footrest 122 can be moved by the user, as needed, so that the tool 104 can be comfortably driven into post holes of varying depth. The footrest 122 is sized and shaped to accommodate at least one foot 114 of a user 106.

Further, in operation the twist-pick tool 104 operates with a twisting motion and has a T-shaped crossbar component 126 that enable users 106 to maintain a secure grip on the tool 104 while twisting the blade 116 back and forth about its long axis to loosen compacted earth 108 in the bottom of a post hole. The loosened earth is then easily and rapidly removed by a post hole digger.

In yet another embodiment, the multipurpose foot-powered system 100 comprises a plurality of indicia 500. The kick-pick tool 102 and twist-pick tool 104 may include advertising, a trademark, or other letters, designs, or characters, printed, painted, stamped, or integrated into the kick-pick tool 102 or the twist-pick tool 104, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be tool, compacted earth, or brand related.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “multipurpose foot-powered system”, “foot-powered system”, “multipurpose system”, and “system” are interchangeable and refer to the multipurpose foot-powered system 100 of the present invention.

Notwithstanding the forgoing, the multipurpose foot-powered system 100 of the present invention can be of any suitable size and configuration as is known in the art without affecting the overall concept of the invention, provided that it accomplishes the above stated objectives. One of ordinary skill in the art will appreciate that the multipurpose foot-powered system 100 as shown in FIGS. 1-13 is for illustrative purposes only, and that many other sizes and shapes of the multipurpose foot-powered system 100 are well within the scope of the present disclosure. Although the dimensions of the multipurpose foot-powered system 100 are important design parameters for user convenience, the multipurpose foot-powered system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multipurpose foot-powered system that provides a user with a set of tools which break up compacted earth, the multipurpose foot-powered system comprising:
a kick-pick tool; and
a twist-pick tool;
wherein the kick-pick tool and the twist-pick tool are a set of foot-powered and hand-operated tools;
wherein the kick-pick tool resembles a shovel with a hooded steel blade component; and
further wherein the twist-pick tool comprises a tool that is entirely straight from a tip through its handle component, and has a height adjustable footrest and a T-shaped crossbar on a handle component.

2. A kick-pick tool is a tool for easily breaking the structure of compacted soil for numerous purposes, including freeing weeds from soil with their roots, the multipurpose foot-powered system comprising:
a hooded steel blade component;
a handle component;
a shank component;
a footrest platform component; and
wherein the blade component is secured to the footrest platform component;
wherein the footrest platform component is secured to the handle component via the shank component;
wherein the blade component is slightly curved in shape, much like a conventional shovel;
wherein the footrest platform component is positioned at a convenient distance from a tip of the blade component, which will allow a user to drive the hooded steel blade component of the kick-pick tool into earth with their foot; and
further wherein the kick-pick tool operates with a prying motion against the hooded steel blade component as a conventional shovel and breaks structure of the earth that surrounds an embedded object facilitating easy removal.

3. The kick-pick tool of claim 2, wherein the shank component accepts an end of the handle component.

4. The kick-pick tool of claim 3, wherein the handle component is an elongated cylindrical configuration with an opposing first end and a second end.

5. The kick-pick tool of claim 4, wherein a second end is secured to the shank component and a first end is utilized as a gripping section for use by a user.

6. The kick-pick tool of claim 5, wherein the blade component measures approximately 10-16 inches in length as measured from tip to the footrest platform component and is secured to the footrest platform component.

7. The kick-pick tool of claim 6 further comprising a steel hood that is secured about one to four inches back from the tip of the blade component.

8. The kick-pick tool of claim 7, wherein the steel hood is circular, oval, or triangular.

9. The kick-pick tool of claim 8, wherein the footrest serves to offset the handle from the footrest for user convenience in controlling the kick-pick tool.

10. The kick-pick tool of claim 9, wherein the footrest component is sized to retain at least one foot of a user.

11. A twist-pick tool is a tool for easily breaking up material with a twisting motion operating through a hood of a blade, the twist-pick tool comprising:
a hooded pick-like blade component;
a handle component;
a shank component;
a footrest platform component; and
an adjustable footrest;
wherein the blade component is secured to the handle component via the shank component;
wherein the footrest platform component is either integral with or secured to either or both the shank component or the handle component;
wherein the twist-pick tool is entirely straight from its tip through the handle component;
wherein the adjustable footrest is positioned by a user at a convenient distance from a tip of the blade component along the footrest platform component, thus accommodating varying hole depths, which will allow a user to drive the hooded pick-like blade component of the twist-pick device into earth with their foot; and
further wherein the twist-pick tool operates with a twisting motion acting through the hooded pick-like blade component in material to be broken-up.

12. The twist-pick tool of claim 11, wherein the twist-pick tool measures approximately 5-6 feet in length.

13. The twist-pick tool of claim 12, wherein the shank component and the blade component are one integral piece.

14. The twist-pick tool of claim 13, wherein the shank component is secured to the handle component.

15. The twist-pick tool of claim 14, wherein a first end of the handle component comprises a T-shaped crossbar that enables the user to easily twist the twist-pick tool.

16. The twist-pick tool of claim 15, wherein the blade component measures approximately 4-12 inches in length as measured from tip to shank component.

17. The twist-pick tool of claim 16, further comprising a steel hood secured about one to four inches back from the tip of the blade component.

18. The twist-pick tool of claim 17, wherein the adjustable footrest is secured to a footrest platform component, such that allows the adjustable footrest to be moved up and down along the shank component and serves to offset the handle component from the tread of the adjustable footrest for user convenience in controlling the twist-pick tool.

19. The twist-pick tool of claim 18, wherein the adjustable footrest can be moved by the user so that the twist-pick tool can be comfortably driven into post holes of varying depth.

20. The twist-pick tool of claim 19, wherein in operation the twist-pick tool operates with a back and forth twisting motion of the hooded pick-like blade component about its long axis to loosen compacted earth in a bottom of a post hole, loosened earth is then easily and rapidly removed by a post hole digger.
